(19) United States
(12) Patent Application Publication
(10) Pub. No.: US 2024/0232793 A9
(43) Pub. Date: Jul. 11, 2024

(54) INTELLIGENT MANANGEMENT OF INVENTORY ITEMS IN AN INFORMATION PROCESSING SYSTEM

(71) Applicant: Dell Products L.P., Round Rock, TX (US)

(72) Inventors: Rohit Gosain, Bangalore (IN); Shibi Panikkar, Bangalore (IN)

(21) Appl. No.: 17/970,896

(22) Filed: Oct. 21, 2022

(51) Int. Cl. G06Q 10/08; G06Q 30/02

(52) U.S. Cl. CPC G06Q 10/087; G06Q 10/0838; G06Q 30/0202

(57) ABSTRACT

Automated item management techniques are disclosed. For example, for a given item type obtainable from one or more sources and storable as inventory at one of a first site or a second site and based on a given demand forecast, a method classifies the item type based on historical data associated with obtaining the item type from the one or more sources. The method computes a risk factor value for the item type based on one or more risk factors. The method then computes, for the given demand forecast and based on the classifying and the risk factor value, a first amount of the item type to store as inventory at the first site and a second amount of the item type to store as inventory at the second site.

### FIELD

The field relates generally to information processing systems, and more particularly to automated item management in such information processing systems.

### BACKGROUND

There are many technical scenarios whereby entities attempt to manage items in their control with a goal of minimizing one or more negative consequences from occurring. In one example, a management scenario may comprise items (e.g., parts or other raw materials) that an original equipment manufacturer (OEM) obtains from one or more sources for use in manufacturing a product or some other piece of equipment ordered by a customer. Typically, the OEM obtains the parts and provides them to their own factory or factories and/or to one or more original design manufacturers (ODMs) or one or more contract manufacturers (CMs) for them to manufacture the equipment for the OEM.

Further, the OEM typically attempts to determine how many parts will be needed when obtaining parts from the one or more sources. If the inventory management estimate is inaccurate, the OEM will be left with unnecessary inventory. Unfortunately, conventional inventory item management techniques are manual and reactive in nature leading to significant negative technical consequences.

By way of example only, such inaccurate inventory management adds computational burden on the underlying information processing systems that manage inventory with respect to tracking and provisioning/returning excess inventory.

Furthermore, electronic communication networks between information processing systems of the OEM and its partners (e.g., ODMs and CMs) are unnecessarily burdened by extra communication regarding what to do with unnecessary inventory items.

As a secondary consideration, excess inventory that cannot be used elsewhere can place a cost burden on the OEM.

### SUMMARY

Illustrative embodiments provide automated item management techniques comprising risk assessment associated with maintaining items across a plurality of locations in an information processing system.

For example, in an illustrative embodiment, for a given item type obtainable from one or more sources and storable as inventory at one of a first site or a second site and based on a given demand forecast, a method classifies the item type based on historical data associated with obtaining the item type from the one or more sources. The method computes a risk factor value for the item type based on one or more risk factors. The method then computes, for the given demand forecast and based on the classifying and the risk factor value, a first amount of the item type to store as inventory at the first site and a second amount of the item type to store as inventory at the second site.

Advantageously, one or more illustrative embodiments overcome the above and other technical drawbacks associated with existing inventory item management by considering one or more of supplier delivery patterns of a specific part, transport proximity of the supplier to manufacturing locations, and other dependent factors to compute the appropriate percentage distribution for vendor-owned inventory and OEM-owned inventory for a specific vendor committed quantity using intelligent classification and other machine learning techniques.

These and other illustrative embodiments include, without limitation, apparatus, systems, methods and computer program products comprising processor-readable storage media.

### BRIEF DESCRIPTION OF THE DRAWINGS

FIG. 1 illustrates an inventory management environment with which one or more illustrative embodiments can be implemented.

FIG. 2 illustrates a graphic of a percentage distribution of inventory between two entities for a use case with which one or more illustrative embodiments can be implemented.

FIG. 3 illustrates a table of a distribution of inventory between two entities for a use case with which one or more illustrative embodiments can be implemented.

FIG. 4 illustrates an information processing system environment comprising an intelligent inventory item management engine according to an illustrative embodiment.

FIG. 5 illustrates a process flow associated with an intelligent inventory item management engine according to an illustrative embodiment.

FIG. 6 illustrates a graphic of supplier delivery data for items in a use case according to an illustrative embodiment.

FIG. 7 illustrates an intelligent inventory item management methodology according to an illustrative embodiment.

FIG. 8 illustrates an example of a processing platform that may be utilized to implement at least a portion of an information processing system for intelligent inventory item management according to an illustrative embodiment.

### DETAILED DESCRIPTION

Supply chain management in the manufacturing industry typically refers to the process of monitoring and taking actions required for a manufacturer, such as an OEM, to obtain raw materials (i.e., parts) from one or more sources (e.g., suppliers or vendors), convert those parts into a finished product (equipment) at one or more manufacturing facilities (sites), and then deliver or otherwise deploy the equipment at a customer location. A goal of supply chain management with respect to the parts is to adequately manage supply and demand, e.g., the supply of the parts (the parts procured or otherwise acquired from vendors, etc.) versus the demand of the parts (e.g., the parts needed to satisfy the manufacturing of equipment ordered by a customer). Management of the parts has been a challenge in the traditional and now modern supply chain processes.

As mentioned, when an inventory management estimate (supply) is inaccurate, the OEM will be left with unnecessary inventory, which can have significant negative technical consequences on the underlying information processing and communication systems of the OEM. Excess inventory that cannot be used elsewhere can also certainly place an added cost burden on the OEM.

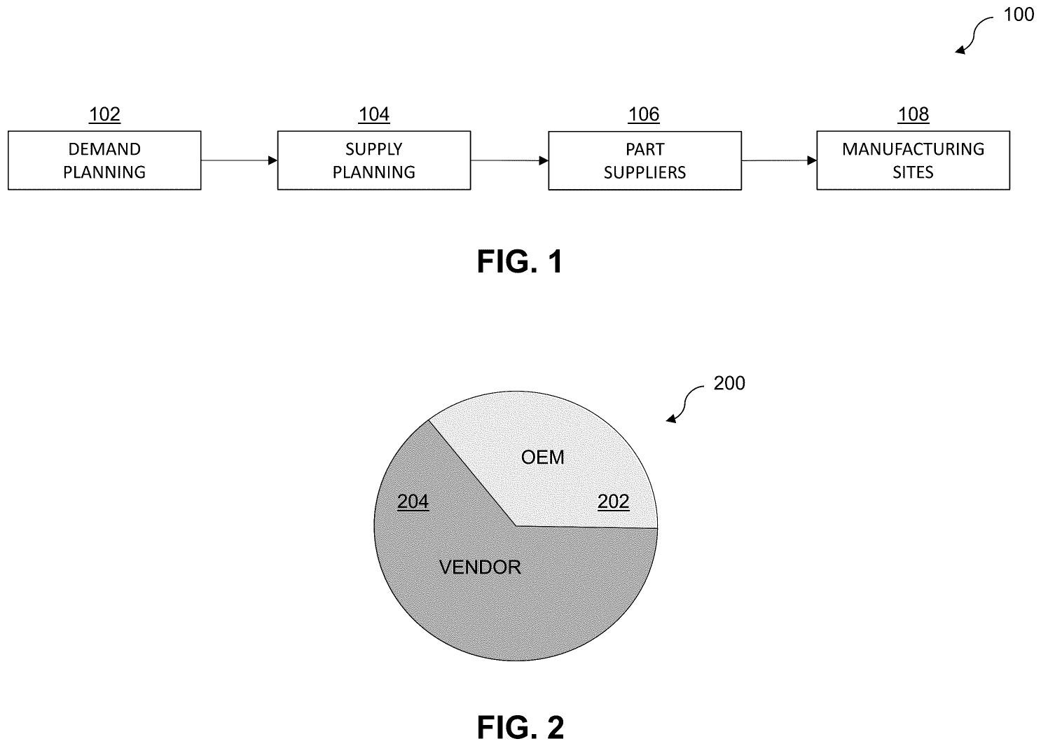

Consider FIG. 1 which illustrates an inventory management environment 100 with which one or more illustrative embodiments can be implemented. As shown, an OEM typically forecasts a demand (demand planning 102). For example, in a scenario where the OEM is a seller of computing and storage devices (e.g., servers, storage arrays, laptops, etc.), a determination has to be made as to how many such devices need to be manufactured over a given time period (e.g., how many laptops need to be manufactured over the next three quarters of a given fiscal year). Then, the OEM has to set in motion a plan to order the parts needed to build the devices (supply planning 104) from one or more vendors or suppliers (parts suppliers 106) in advance to avoid any part shortage during manufacturing (manufacturing sites 108).

Now an issue is whether the OEM should procure all the parts to build all the devices based on the demand forecast and hold them in inventory (at their own facilities and/or at ODMs/CMs). If the OEM procures all parts needed upfront, there can be issues such as, for example:
(i) Demand forecasting may not be accurate and actual orders may be far less or far more than forecasted. As a result, the OEM will be overstocking and therefore paying upfront and incurring loss.
(ii) Overstock of outdated technology can occur, e.g., if a laptop OEM procures and stocks all processors of a first version, but over time, the demand changes for laptops with a newer version.
(iii) Burden on underlying information processing systems, e.g., as mentioned part overstock adds computational burden on the underlying information processing systems that manage inventory with respect to tracking and provisioning/returning excess inventory, as well as on electronic communication networks between information processing systems of the OEM and its partners (e.g., ODMs and CMs) that are unnecessarily burdened by extra communication regarding what to do with unnecessary inventory items.

However, if the OEM does not take possession of all the parts called for by the supply planning (based on the demand planning) and keeps all or most of the parts in the vendor's warehouse, then a part shortage at manufacturing sites can occur. Thus, what typically occurs is the OEM purchases (pays upfront) a portion of the forecasted supply (which the OEM has a high probability of using) and the remainder of the forecasted supply is contracted for with the vendor on an as-needed, i.e., the vendor maintains ownership and possession of the parts and the OEM only purchases the parts as needed during manufacturing.

The portion of the forecasted supply that the OEM procures is illustratively referred to herein as “OEM-owned” inventory and rest of the forecasted supply is illustratively referred to herein as “vendor-owned” inventory. While the OEM does not purchase up-front the vendor-owned inventory, typically the underlying information processing system associated with the OEM's inventory management system tracks the vendor-owned inventory for potential procurement for upcoming customer orders.

Now the question becomes, what percentage of the forecasted supply should the OEM keep as OEM-owned inventory versus vendor-owned inventory. From a cost perspective, the OEM would try to keep the OEM-owned inventory as low as possible, so that the OEM need not pay upfront. Currently, however, this percentage is manually calculated by the OEM based on current order backlog and safety stock (e.g., a minimum level of inventory that the OEM keeps in the manufacturing locations): OEM-owned Inventory=Backlog+Safety Stock+Some Buffer %+Experience; where Backlog refers to parts required for current customer orders, and Safety Stock refers to minimum parts stocked in manufacturing locations. FIG. 2 illustrates a graphic 200 of a percentage distribution of OEM-owned inventory 202 (e.g., about 30%) versus vendor-owned inventory 204 (e.g., about 70%) for a given forecasted supply use case. Currently, there is no systematic way to compute these percentages.

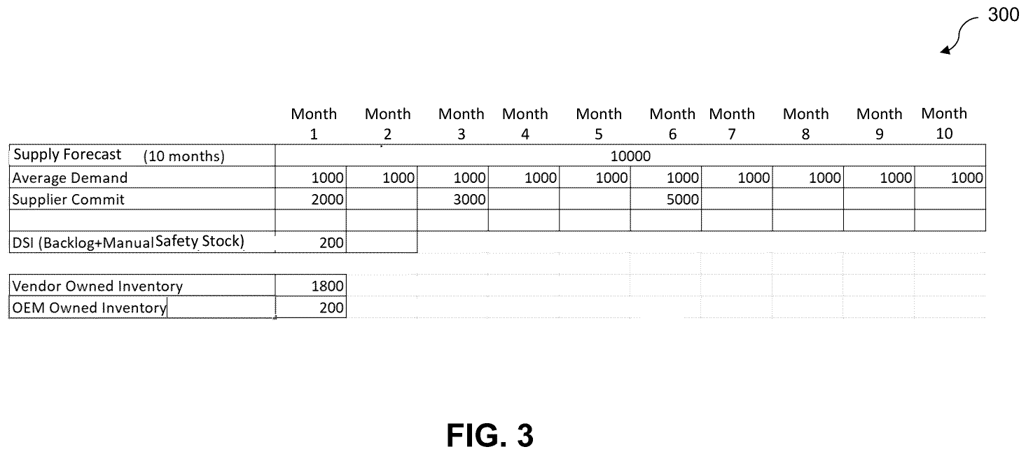

Consider the example depicted in a table 300 of FIG. 3. Assume that a supply forecast for part A is 10,000 units for next the 10 months. As such, the average demand is distributed for the next 10 months as 1,000 for each month. Assume that a vendor will not supply part A each month, but may commit to transport in month 1 (2,000 units), month 3 (3,000 units), and month 6 (5,000 units), according to their transportation effectiveness.

Now the question is how much from the 2,000 units should the OEM take as OEM-owned inventory (OEM pays upfront and stocks the parts in its manufacturing locations upfront) versus vendor-owned inventory (OEM does not pay upfront but asks the vendor to keep the parts available in the vendor warehouse). However, the OEM considers the entire 2,000 units available while planning the order.

What the OEM needs, at minimum, is the number of parts for current orders that are not yet manufactured (backlogs) plus a minimum number of parts to keep in the manufacturing locations (safety stock). This sum (backlog+safety stock) is illustratively referred to as “days sales inventory” (DSI). Assume, in a most optimistic way, the OEM splits total inventory as DSI number being the OEM-owned inventory (i.e., 200 as shown in table 300 of FIG. 3) paid for upfront and stocked at the manufacturing locations, and the remainder vendor-owned inventory (i.e., 1,800 as shown in table 300 of FIG. 3) and stocked at the vendor warehouse.

Thus, it is realized that 1,800 units are at risk, as the vendor may delay transporting this material to the OEM since the OEM has not yet paid for it. Typically, the OEM procurement team adds some buffer amount to the OEM-owned inventory, however, this is purely based on historical assignment and the procurement team's experience.

It is further realized that an OEM does not want to take the entire supply commit from the vendor as OEM-owned inventory even though this would eliminate the shortage risk. Some reasons for this include, but are not limited to: (i) paying entire cost for the supply commit upfront; (ii) the supply forecast may not be accurate; (iii) the above-mentioned possibility that the technology changes and the stocked inventory becomes obsolete; and/or (iv) the possibility of price variations, i.e., if the price goes down, the OEM will not be able to realize that decrease for stock already purchased.

Thus, there is a need to find an optimal partitioning between vendor-owned inventory and OEM-owned inventory. To add to the complexity, some vendors may be very prompt in delivery of some specific material but consistently delay the supply of some other specific material. Further complexity exists when an OEM sources the same item from more than one supplier with each supplier exhibiting different behavior with respect to delivery. Currently, there is no optimal way to calculate the percentage of inventory that is vendor-owned versus OEM-owned.

Illustrative embodiments overcome the above and other technical drawbacks with current inventory item management by providing a methodology and system to compute an appropriate (e.g., optimal) percentage of inventory that is vendor-owned versus OEM-owned. More particularly, in one or more illustrative embodiments, the technical solution considers one or more of supplier delivery patterns of a specific part, transport proximity of the supplier to manufacturing locations, and other dependent factors to compute the appropriate percentage distribution for vendor-owned inventory and OEM-owned inventory for a specific vendor committed quantity using intelligent classification and machine learning techniques.

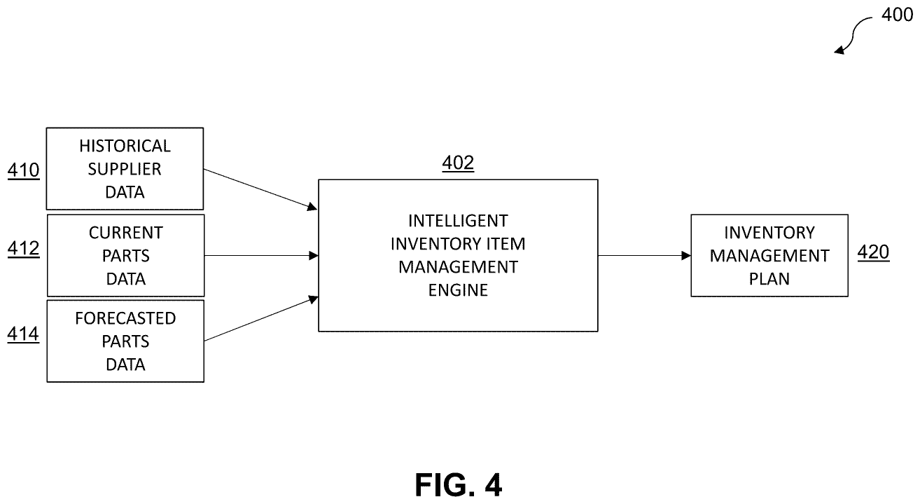

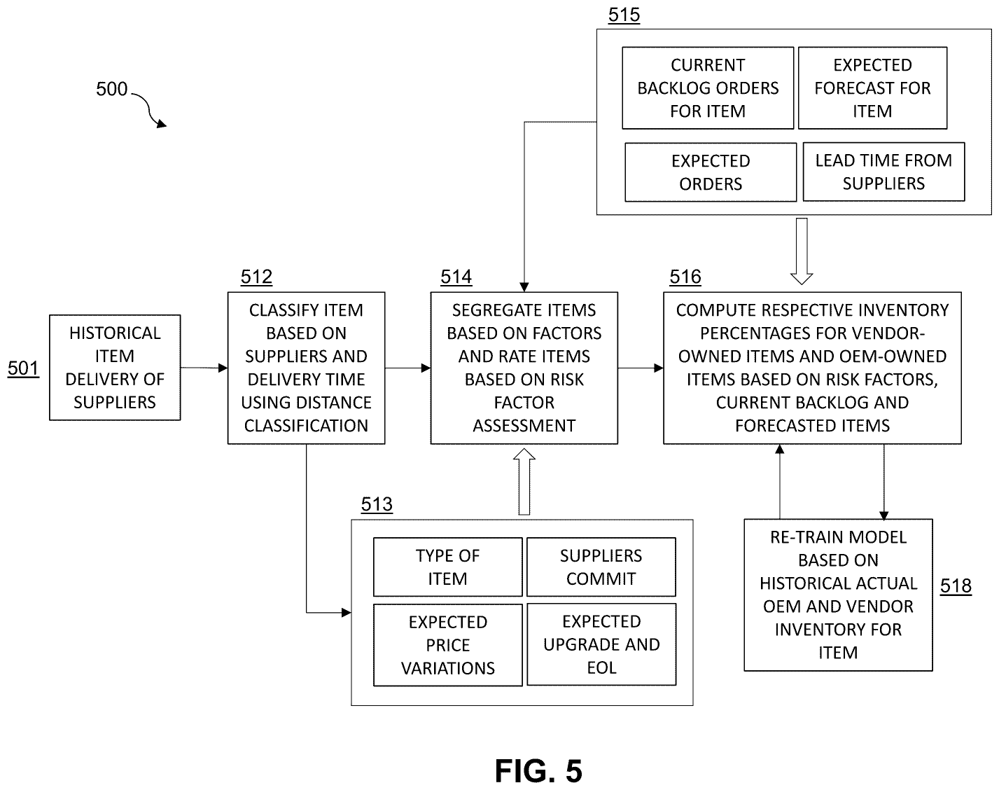

Referring now to FIG. 4, an information processing system environment 400 is depicted according to an illustrative embodiment. As generally shown, an information processing system environment 400 comprises an intelligent inventory item management engine 402 which receives, as input data, historical supplier data 410, current part data 412, and forecasted parts data 414. Based on at least a portion of the input data, intelligent inventory item management engine 402 computes an inventory management plan 420 using intelligent classification and machine learning techniques, as will be further explained below in the context of FIG. 5. Inventory management plan 420 comprises an appropriate percentage distribution for vendor-owned inventory and OEM-owned inventory for a specific vendor committed quantity. This automated computation of percentage distribution helps to reduce the risk of parts shortage, overspending, expected technology variations, and added burden on underlying information processing and communication systems (e.g., lessens compute cycles, storage units, and/or network overhead).

Turning now to FIG. 5, a process flow 500 associated with intelligent inventory item management engine 402 is depicted according to an illustrative embodiment. As shown, data 501 representing historical item (part or other raw material) delivery of one or more suppliers is input to step 512.

Step 512 classifies the item based on suppliers and delivery time using a distance classification engine. Assume the following:
(i) One item is sourced from more than one supplier, e.g., if 1000 units of part X are needed, 200 will be sourced from Supplier 1, 300 from Supplier 2, 250 from Supplier 3, and 250 from Supplier 4. This is called the total available or addressable market (TAM) in the OEM industry.
(ii) Input data 501 indicates that each supplier has different historical behavior with respect to the delivery of different items. Supplier 1 may be supplying raw material X and Y where they may deliver part X on time, however, may have a pattern of delaying part Y.

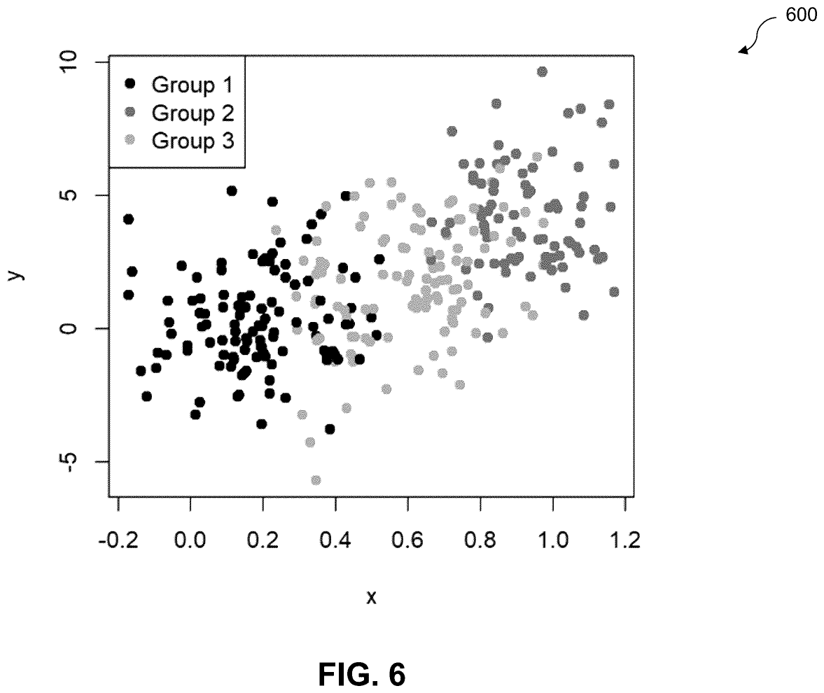

Accordingly, step 512 classifies the parts based on historical supplier delivery behavior as input (501) using a supervised distance-based classification algorithm. This is illustrated in a data plot 600 of FIG. 6. Note that as delivery is delayed for each part X and Y, the distance from the reference increases in the data plot.

Assume two suppliers (Supplier 1, Supplier 2) and two items (Item 1, Item 2). Assume that Supplier 1 supplies Item 1 (shown as x in data plot 600) and Item 2 (shown as y in data plot 600), but Supplier 2 supplies only Item 2. Item 1 is delivered by Supplier 1 and Supplier 2 in the TAM ratio of 70% and 30%, respectively. The data is plotted via step 512 in three groups as follows: Group 1—Supplier 1, Item 1; Group 2—Supplier 2, Item 1; and Group 3—Supplier 1, Item 2.

It is evident in data plot 600 that Supplier 1 delivers Item 1 consistently on time (with a few outliers), however, delays Item 2 almost consistently. Supplier 2 delivers Item 1 slower than Supplier 2, however, not consistently late. Accordingly, Item 1 from Supplier 1 is delivered consistently fast (70%) and delivered from Supplier 2 with some delay (30%). Item 2 is from Supplier 1 (100%) and most of the time is delayed. Step 512 thus determines the delivery behavior of Item 1 and Item 2.

Turning now to step 514 of process flow 500, items are segregated based on one or more factors and rated based on a risk factor assessment. More particularly, input data 513 (item type, suppliers commit, expected price variations, and expected product upgrade and end-of-life or EOL) is provided to step 514 along with the results of the classification operations in step 512.

Since supplier behavior on the delivery of the items is known (step 512), process flow 500 in step 514 we can start ranking items. For example, in one or more illustrative embodiments, step 514 uses a weighted model predictive control algorithm. The algorithm regards the historical data from step 512 and input data 513 as the source domain data and target domain data, respectively, in a transfer learning operation. Then, by learning a distribution mapping function of the source domain to target domain, an importance weight of all the source domain data is obtained. Finally, a predictive model is learned by weighted kernel ridge regression, with error compensation and rolling optimization applied to realize stable controls for a complex industrial process.

It is to be appreciated that there are several factors that can be involved in a risk prediction for an item delivery (these factors are embodied by input data 513):
(i) Type of item, i.e., generic or specific. More particularly, generic items are replaceable with other raw materials, e.g., a Samsung SDRAM can be replaced with a Powerchip SDRAM. However, an Intel processor cannot be replaced because the Intel chip is design specific. As such, all design-specific parts (such as the processor) are placed in a high-risk category.
(ii) Expected price variations. If the OEM is expecting a price variation in the future, the risk of buying and keeping (OEM-owned inventory) increases.
(iii) Expected upgrade/change in technology or EOL. Any of these factors signal an increase in risk for buying and keeping such items.
(iv) Supplier commit, i.e., the interval of supplier commit to supply material based on the demand. If a supplier did not commit on time, the risk increases. Here, the OEM needs to buy and stock the item.

These factors vary by the product that the OEM intends to manufacture. According to the product, a data analytics/procurement team can set the weightage based on a rating for each of the factors. The supplier delivery behavior and these factors are fed to the weighted model. Based on the input and the weighted model, the risk scale can be set between 1-5 for an item (e.g., 1 as least risk and 5 as highest risk of having more vendor-owned inventory).

Returning to the above example, for Item 1, 70% of the item supply is from Supplier 1 who delivers on time. Assume Item 1 is generic, has no expected price variations, has no expected upgrade in the next 6 months and EOL for another year. Thus, in this scenario, the item is rated as least risk, i.e., risk factor 1. In this case, the OEM can keep as a maximum percentage of vendor-owned inventory and a minimum percentage of OEM-owned inventory, as well as a low safety stock.

Contrast that with Item 2 which is supplied by Supplier 2 and 100% is delayed delivery. Assume the item is a specific product, but with no likelihood of upgrade in technology in the next year. This item is rated as risk factor 5, which will lead to keeping a minimum percentage of vendor-owned inventory and a maximum percentage of OEM-owned inventory. In this case, OEM may also need to keep the safety stock as high as possible.

Thus, in existing approaches, while the decision on what percentage of total demand should be OEM-owned versus vendor-owned is manually made by the manufacturing/procurement teams, illustrative embodiments systematically derive a risk factor from a risk factor scale (e.g., 1-5 for all items). Next, process flow 500 in step 516 determines the final percentages based, for example, on risk factors, the current backlog, and forecasted items.

More particularly, step 516 receives the results of step 514 as well as input data 515 (current backlog orders for item, expected forecast for item, expected orders, and lead time from suppliers) and computes the respective percentages of vendor-owned inventory and OEM-owned inventory based on this information. As mentioned, step 516 depends on the current backlogs and future forecast of the item.

Recall that in the example of table 300 of FIG. 3, the percentages were based on the experience of the procurement team (vendor-owned 1,800 versus OEM-owned 200). Now, in accordance with process flow 500, a systematic view and automated decision recommender is available to the OEM. In the above case for Item 1, step 516 may tend to keep a minimum OEM-owned inventory as the risk factor is 1, and may even suggest the lowest safety stock. As such, step 516 may predict the vendor-owned inventory as 1,900 and the OEM-owned inventory as 100, as well as reducing the safety stock from 75 to 50. This is because the system knows that the item will be delivered on time, and there is a risk of upgrade. So it would be better not to buy upfront but keep the inventory with the vendor and obtain it as and when required.

For Item 2, the risk factor is 5. So, the system would recommend buying as much as possible upfront, as there is a delivery issue with the supplier and there is no risk of buying as no upgrade and EOL is going to happen for that product. So, the system may suggest a vendor-owned inventory as 500 and an OEM-owned inventory as 1,500.

It is to be appreciated that process flow 500 can be (re-)trained in step 518 with different weightage and percentage divisions for the risk factors and compared with historical actual data to improve accuracy. Advantageously, the system will learn in case of overspend or part shortage due to the predicted percentages and adjust as appropriate. The system model can run for each weekly cycle of the supply demand planning for the shortest planning cycle for a specific industry.

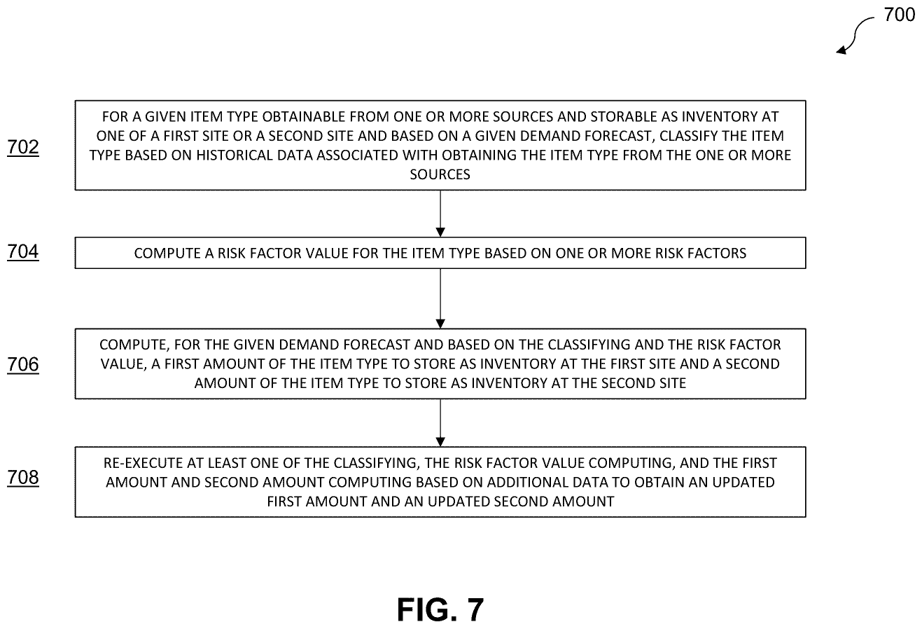

FIG. 7 summarizes an intelligent inventory item management methodology 700, according to an illustrative embodiment. As shown, step 702, for a given item type obtainable from one or more sources and storable as inventory at one of a first site (e.g., one of the vendor or supplier warehouses where vendor-owned inventory is stored) or a second site (e.g., an OEM-based site where OEM-owned inventory is stored) and based on a given demand forecast, classify the item type based on historical data associated with obtaining the item type from the one or more sources. Step 704 computes a risk factor value for the item type based on one or more risk factors. Step 706 computes, for the given demand forecast and based on the classifying and the risk factor value, a first amount (e.g., a first percentage distribution) of the item type to store as inventory at the first site and a second amount (e.g., a second percentage distribution) of the item type to store as inventory at the second site. Step 708 re-executes at least one of the classifying, the risk factor value computing, and the first amount and second amount computing based on additional data to obtain an updated first amount and an updated second amount.

Illustrative embodiments are described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources. Cloud infrastructure can include private clouds, public clouds, and/or combinations of private/public clouds (hybrid clouds).

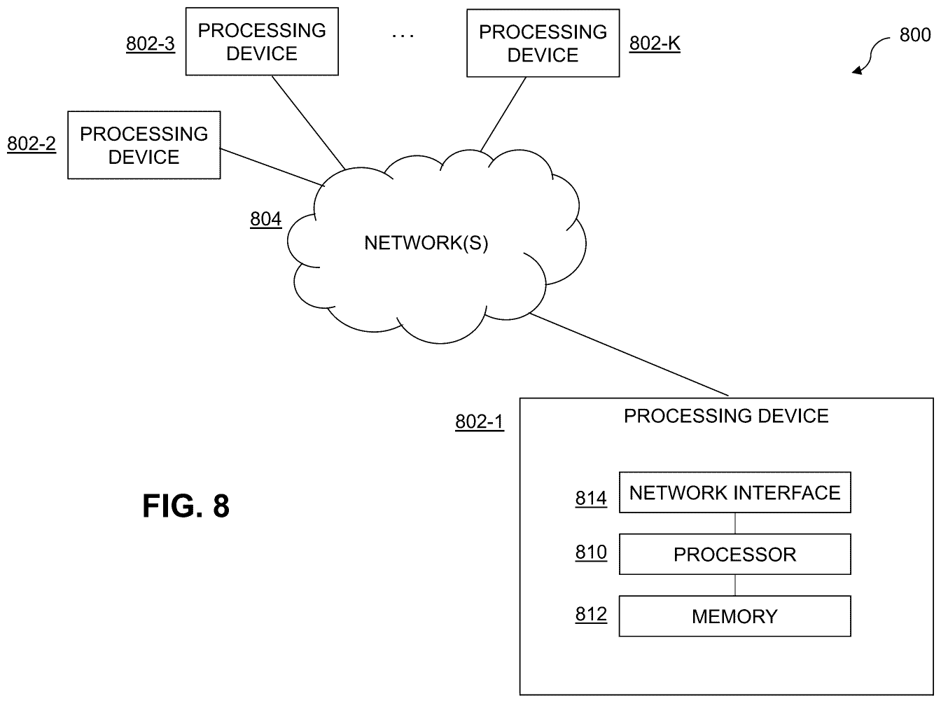

FIG. 8 depicts a processing platform 800 used to implement systems/processes/data depicted in FIGS. 1 through 7, respectively, according to an illustrative embodiment. More particularly, processing platform 800 is a processing platform on which a computing environment with functionalities described herein can be implemented.

The processing platform 800 in this embodiment comprises a plurality of processing devices, denoted 802-1, 802-2, 802-3, . . . 802-K, which communicate with one another over network(s) 804. It is to be appreciated that the methodologies described herein may be executed in one such processing device 802, or executed in a distributed manner across two or more such processing devices 802. It is to be further appreciated that a server, a client device, a computing device or any other processing platform element may be viewed as an example of what is more generally referred to herein as a “processing device.” As illustrated in FIG. 8, such a device generally comprises at least one processor and an associated memory, and implements one or more functional modules for instantiating and/or controlling features of systems and methodologies described herein. Multiple elements or modules may be implemented by a single processing device in a given embodiment. Note that components described in the architectures depicted in the figures can comprise one or more of such processing devices 802 shown in FIG. 8. The network(s) 804 represent one or more communications networks that enable components to communicate and to transfer data therebetween, as well as to perform other functionalities described herein.

The processing device 802-1 in the processing platform 800 comprises a processor 810 coupled to a memory 812. The processor 810 may comprise a microprocessor, a microcontroller, an application-specific integrated circuit (ASIC), a field programmable gate array (FPGA) or other type of processing circuitry, as well as portions or combinations of such circuitry elements. Components of systems as disclosed herein can be implemented at least in part in the form of one or more software programs stored in memory and executed by a processor of a processing device such as processor 810. Memory 812 (or other storage device) having such program code embodied therein is an example of what is more generally referred to herein as a processor-readable storage medium. Articles of manufacture comprising such computer-readable or processor-readable storage media are considered embodiments of the invention. A given such article of manufacture may comprise, for example, a storage device such as a storage disk, a storage array or an integrated circuit containing memory. The term “article of manufacture” as used herein should be understood to exclude transitory, propagating signals.

Furthermore, memory 812 may comprise electronic memory such as random-access memory (RAM), read-only memory (ROM) or other types of memory, in any combination. The one or more software programs when executed by a processing device such as the processing device 802-1 causes the device to perform functions associated with one or more of the components/steps of system/methodologies in FIGS. 1 through 7. One skilled in the art would be readily able to implement such software given the teachings provided herein. Other examples of processor-readable storage media embodying embodiments of the invention may include, for example, optical or magnetic disks.

Processing device 802-1 also includes network interface circuitry 814, which is used to interface the device with the network(s) 804 and other system components. Such circuitry may comprise conventional transceivers of a type well known in the art.

The other processing devices 802 (802-2, 802-3, . . . 802-K) of the processing platform 800 are assumed to be configured in a manner similar to that shown for computing device 802-1 in the figure.

The processing platform 800 shown in FIG. 8 may comprise additional known components such as batch processing systems, parallel processing systems, physical machines, virtual machines, virtual switches, storage volumes, etc. Again, the particular processing platform shown in this figure is presented by way of example only, and the system shown as 800 in FIG. 8 may include additional or alternative processing platforms, as well as numerous distinct processing platforms in any combination.

Also, numerous other arrangements of servers, clients, computers, storage devices or other components are possible in processing platform 800. Such components can communicate with other elements of the processing platform 800 over any type of network, such as a wide area network (WAN), a local area network (LAN), a satellite network, a telephone or cable network, or various portions or combinations of these and other types of networks.

Furthermore, it is to be appreciated that the processing platform 800 of FIG. 8 can comprise virtual (logical) processing elements implemented using a hypervisor. A hypervisor is an example of what is more generally referred to herein as “virtualization infrastructure.” The hypervisor runs on physical infrastructure. As such, the techniques illustratively described herein can be provided in accordance with one or more cloud services. The cloud services thus run on respective ones of the virtual machines under the control of the hypervisor. Processing platform 800 may also include multiple hypervisors, each running on its own physical infrastructure. Portions of that physical infrastructure might be virtualized.

As is known, virtual machines are logical processing elements that may be instantiated on one or more physical processing elements (e.g., servers, computers, processing devices). That is, a “virtual machine” generally refers to a software implementation of a machine (i.e., a computer) that executes programs like a physical machine. Thus, different virtual machines can run different operating systems and multiple applications on the same physical computer. Virtualization is implemented by the hypervisor which is directly inserted on top of the computer hardware in order to allocate hardware resources of the physical computer dynamically and transparently. The hypervisor affords the ability for multiple operating systems to run concurrently on a single physical computer and share hardware resources with each other.

It was noted above that portions of the computing environment may be implemented using one or more processing platforms. A given such processing platform comprises at least one processing device comprising a processor coupled to a memory, and the processing device may be implemented at least in part utilizing one or more virtual machines, containers or other virtualization infrastructure. By way of example, such containers may be Docker containers or other types of containers.

The particular processing operations and other system functionality described in conjunction with FIGS. 1-8 are presented by way of illustrative example only, and should not be construed as limiting the scope of the disclosure in any way. Alternative embodiments can use other types of operations and protocols. For example, the ordering of the steps may be varied in other embodiments, or certain steps may be performed at least in part concurrently with one another rather than serially. Also, one or more of the steps may be repeated periodically, or multiple instances of the methods can be performed in parallel with one another.

It should again be emphasized that the above-described embodiments of the invention are presented for purposes of illustration only. Many variations may be made in the particular arrangements shown. For example, although described in the context of particular system and device configurations, the techniques are applicable to a wide variety of other types of data processing systems, processing devices and distributed virtual infrastructure arrangements. In addition, any simplifying assumptions made above in the course of describing the illustrative embodiments should also be viewed as exemplary rather than as requirements or limitations of the invention.

What is claimed is:

1. An apparatus comprising:
at least one processing device comprising a processor coupled to a memory, the at least one processing device, when executing program code, is configured to:
for a given item type obtainable from one or more sources and storable as inventory at one of a first site or a second site and based on a given demand forecast, classify the item type based on historical data associated with obtaining the item type from the one or more sources;
compute a risk factor value for the item type based on one or more risk factors; and
compute, for the given demand forecast and based on the classifying and the risk factor value, a first amount of the item type to store as inventory at the first site and a second amount of the item type to store as inventory at the second site.

2. The apparatus of claim 1, wherein the at least one processing device, when executing program code, is further configured to re-execute at least one of the classifying, the risk factor value computing, and the first amount and second amount computing based on additional data to obtain an updated first amount and an updated second amount.

3. The apparatus of claim 1, wherein the first site comprises one or more sites of the respective one or more sources and the second site comprises a site of an entity responsible for the given demand forecast.

4. The apparatus of claim 1, wherein the classifying is executed with at least one machine learning algorithm.

5. The apparatus of claim 4, wherein the at least one machine learning algorithm comprises a supervised distance-based classification algorithm.

6. The apparatus of claim 1, wherein the risk factor value computing is executed with at least one machine learning algorithm.

7. The apparatus of claim 6, wherein the at least one machine learning algorithm comprises a weighted model predictive control algorithm.

8. The apparatus of claim 1, wherein the risk factor value computing is executed based on one or more of the item type, a variation of an attribute of the item type, and an attribute of a commitment by the one or more sources.

9. The apparatus of claim 1, wherein the first amount of the item type to store as inventory at the first site is a first percentage and the second amount of the item type to store as inventory at the second site is a second percentage, wherein a sum of the first percentage and the second percentage correspond to the given demand forecast.

10. The apparatus of claim 1, wherein the item type is a part type used in a manufacturing process of a product by an entity responsible for the given demand forecast.

11. A method comprising:
for a given item type obtainable from one or more sources and storable as inventory at one of a first site or a second site and based on a given demand forecast, classifying the item type based on historical data associated with obtaining the item type from the one or more sources;
computing a risk factor value for the item type based on one or more risk factors; and
computing, for the given demand forecast and based on the classifying and the risk factor value, a first amount of the item type to store as inventory at the first site and a second amount of the item type to store as inventory at the second site;
wherein the classifying and computing steps are performed by at least one processing device comprising a processor coupled to a memory when executing program code.

12. The method of claim 11, further comprising re-executing at least one of the classifying, the risk factor value computing, and the first amount and second amount computing based on additional data to obtain an updated first amount and an updated second amount.

13. The method of claim 11, wherein the first site comprises one or more sites of the respective one or more sources and the second site comprises a site of an entity responsible for the given demand forecast.

14. The method of claim 11, wherein the classifying is executed with at least one machine learning algorithm.

15. The method of claim 14, wherein the at least one machine learning algorithm comprises a supervised distance-based classification algorithm.

16. The method of claim 11, wherein the risk factor value computing is executed with at least one machine learning algorithm.

17. The method of claim 16, wherein the at least one machine learning algorithm comprises a weighted model predictive control algorithm.

18. The method of claim 11, wherein the risk factor value computing is executed based on one or more of the item type, a variation of an attribute of the item type, and an attribute of a commitment by the one or more sources.

19. The method of claim 11, wherein the first amount of the item type to store as inventory at the first site is a first percentage and the second amount of the item type to store as inventory at the second site is a second percentage, wherein a sum of the first percentage and the second percentage correspond to the given demand forecast.

20. A computer program product comprising a non-transitory processor-readable storage medium having stored therein program code of one or more software programs, wherein the program code when executed by at least one processing device cause the at least one processing device to:
for a given item type obtainable from one or more sources and storable as inventory at one of a first site or a second site and based on a given demand forecast, classify the item type based on historical data associated with obtaining the item type from the one or more sources;
compute a risk factor value for the item type based on one or more risk factors; and
compute, for the given demand forecast and based on the classifying and the risk factor value, a first amount of the item type to store as inventory at the first site and a second amount of the item type to store as inventory at the second site.
